(19) United States
(12) Patent Application Publication
(10) Pub. No.: US 2023/0267256 A1
(43) Pub. Date: Aug. 24, 2023

(54) Method and Apparatus for design a PDN of an assembly of VRM-Board-Decoupling-Package-Chip

(71) Applicant: ILIYA GAVRIILOVICH ZAMEK, EAST PALO ALTO, CA (US)

(72) Inventor: ILIYA GAVRIILOVICH ZAMEK, EAST PALO ALTO, CA (US)

(21) Appl. No.: 18/045,144

(22) Filed: Oct. 8, 2022

Related U.S. Application Data
(60) Provisional application No. 63/262,340, filed on Oct. 9, 2021.

(51) Int. Cl. G06F 30/367; G06F 30/39; G06F 30/373

(52) U.S. Cl. CPC G06F 30/367; G06F 30/39; G06F 30/373; G06F 2119/06

(57) ABSTRACT

The present invention relates to the design of a Power Delivery Network (PDN) of a system of VRM-Board-Decoupling Capacitances-Package-Chip for the nm-CMOS devices that typically suffers from the resonances, transient oscillations, and voltage Decay, which resulted in the device fails the specification that often considered as a design flaw and leads to the costly devices respins. Present invention provides a new method, an apparatus or Tool, and a process to design PDN without noted deficiencies, which achieved by damping PDN at setting elevated impedances, in contrast with the common practice of lowering them, which improves the devices performance and reduces the rate of the chips respins. This invention also includes an advanced process that enable to start design early and simultaneously by different engineering groups without disclosing the proprietary information which they might have.

### CROSS REFERENCE TO RELATED APPLICATIONS

This application claims priority from U.S. Provisional Patent Application No. 63/262,340 filed Oct. 9, 2021, and entitled “Method and Apparatus for design a PDN of an assembly of VRM-Board-Decoupling-Package-Chip”. This provisional application is herein incorporated by reference [25].

### BACKGROUND OF THE INVENTION

The present invention relates to the design of a Power Delivery Network (PDN) of a system of VRM-Board-Decoupling Capacitances-Package-Chip for the nm-CMOS devices. More particularly, the invention relates to the design and manufacturing assemblies of VRM, Boards, Packages with substrates and interposers, Decoupling capacitors placed on-board, on-package, and on-chip, and electronic devices like chips of Microprocessors, ASICs, FPGAs, etc.

Power Delivery Network (PDN) provides the voltage from the voltage regulator module (VRM) through the printed circuit boards (PCB) and package to the chip' die. The Chip contains many different components like nm-transistors and logic elements that belong to the chip die, a multilayer stuck-up like package and board have, the power and ground network of the interconnect that includes numerous vias and traces to provide the current from the VRM to various levels of the board, package, and chip die to maintain the stable voltage on-die; additionally, the PDN have many on-die, on-chip, and might have on-package decoupling capacitors to provide current (charge) from decoupling capacitors to the chip die when current from the VRM is not available or delayed due to slow VRM reaction in time.

Each transistor of the CMOS chip has parasitic capacitances that at a big number of the chip transistors sum to the relatively big on-die capacitor C_{die}. At each chip logic transition this capacitance is discharging and the role of the VRM and decoupling capacitors is to replenish the discharge of the on-die capacitor and maintain on its stable voltage.

The whole system of a PDN is very complex. Improper design of the PDN network results in appearing resonances and transient oscillations in a PDN that cause the voltage variations on-die' transistors, which variations might be characterized by voltage MAX and MIN; these voltage variations cause power noise, and timing variations of a signals of on-die logic named power induced jitter. The jitter and power noise reduce the performance of the whole assembly, and particular, maximum achievable speed of operation. On another side, the limited capacitances number, their limited capacity, and/or increased time constant of the charge delivery from decoupling capacitors to the chip' on-die capacitors, result in the reduced on-die voltage,—when chip logic starts switching repeatedly it causes the voltage on-die decay. Both, voltage MAX/MIN and decay are negatively impact the product (assembly) performance. The reduced performance typically revealed at chip validation and often interpreted as a design flaw that might lead to the costly design re-tapeout (respin).

Accordingly, the complexity of the PDN system requires a need to provide a Method, and a Tool (Apparatus) for the analysis, design, and improvements of the PDN of the nm-CMOS devices to improve the devices performance and reduce their rate of respin.

### PRIOR ART AND DISADVANTAGES OF THE PRIOR ART METHOD

(Prior Art description) The principles of the PDN design have been developed more than 20 years ago [1-5] and these principals are widely in use today at design modern assemblies of the nm-devices. The assembly includes PCB with power and ground planes, VRM, decoupling capacitors, and IC package with a Chip [1-5]. The simplest PCB's power and ground interconnect represents the pair of conductive planes which is illustrated in FIG. 1,—a perspective view of a pair of rectangular copper conductive planes 110 and 120 separated by a fiberglass-epoxy composite dielectric layer. The simplified PDN schematic is presented on FIG. 2. A switching power supply 210 supplies current and voltage to a CMOS chip load 220. In parallel with the power supply 210, and the load 220 there are decoupling capacitors 215 and the capacitance of the PCB 225. The prior Art Method includes the calculations of the PDN parameters like PDN loop equivalent series inductance (ESL) designated as L, and equivalent series resistance (ESR) named R, on-die capacitance C_{die}, and based on these parameters calculate:
a resonance frequency of a PDN loop

$${F}_{n} = \frac{1}{2 π \sqrt{L \cdot {C}_{d i e}}} ;$$

characteristic impedance

$$ρ = \sqrt{\frac{L}{{c}_{d i e}}} ,$$

where L is the equivalent inductance of the PDN loop;

$$- Q - factor = \frac{ρ}{R} ,$$

where R is the equivalent series resistance of a PDN loop;

In the prior Art the board impedance Z_{board}, which is PDN impedance from the power rail to the ground rail (name it “vertical” impedance), should be lower compared to the Target Impedance

$${Z}_{T} = \frac{{V}_{d d} \cdot tolerance}{{I}_{max} - {I}_{min}} ,$$

where V_{dd}·tolerance−voltage variations ΔV_{spec} set by the chip designers and might be found in a chip specification; maximum chip current variations ΔI_{spec}=Iₘₐₓ−Iₘᵢₙ; V_{dd} is a nominal power voltage on the chip die. The Prior Art guidance is that the board impedance should be lower than target impedance:

Z_{board}<Z_{T} (1)

The Z_{T} value calculated in the Prior Art based on the data ΔV_{spec}/ΔI_{spec} specified in the chip specification. It represents a digit with the unit in Ohm. For example, if the tolerance is 5% of nominal voltage Vdd=1.8V and the maximum current variation is 1 A, then

$${Z}_{T} = \frac{1.8 V \cdot 0.05}{1 A} = 9 m Ohm ,$$

which marked as 310 in FIG. 3. The board impedance in actual design is frequency dependent Z_{board} (ω) which is illustrated and marked by 320 in FIG. 3.

As FIG. 3 illustrates, inequality (1) meets in this example from 1.E+5 to 1.E+8 frequency, which is from 100 kHz to 100 MHz. To achieve flat board impedance, the method in prior Art guides that decoupling capacitors parameters, their values, and location on the board should be chosen such that their capacitances reactiveness are compensated by inductive reactiveness to be flat within a frequency of interest. When impedance is flat the complex board impedance might be replaced by a resistance R_{board}. Modern nm-CMOS devices have the operating frequency in GHz range, current' variations up to hundreds of Amperes, and required acceptable voltage variations in the millivolt range, which makes a calculated value of Z_{T} being in some microOhms. When designers trying to achieve so small PDN impedances it creates huge resonances and transients in the assembly instead. As it was shown [17], this guidance is wrong and Z_{T} should not be used as a guideline.

From the theory of RLC circuits, which the PDN is, it is well known that at low resistance of a circuit, the Q-factor, resonances, and transient processes in a circuit are rising. Therefore, reducing a PDN impedance at using the TI approach often leads to appearing voltage variations and transient oscillations in the PDN that result in poor device performance and failures. These failures revealed at chip validation are considered as a design flaw and led to the costly assembly respins. This TI method has been widely accepted in the industry due to the powerful support from such industry giant as Sun Microsystem which was an assignee of some of the first PDN patents [1-4]. Later the TI method was further developed [6-11], but main method principle still remains the same and governs by equation (1).

Another prior art problem with the common approach is that how low the PDN impedance should be, was not specified. This created an illusion that “low” board impedance is always better. For this reason, the “low and flat” impedance principle has appeared, spread widely, and is frequently used in the industry. As a result, the TI method is still dominant today as the de-facto industry standard, while it might damage good chips' designs by wrongly guiding the developers and manufacturers to reduce uncontrollable the PDN impedances of assemblies' parts: board, package, and decoupling. Due to these reasons, numerous costly re-tape outs happen at nm-devices design and manufacturing.

One, who is experienced in post-silicon validation might outline the next typical scenario at using the “low and flat” board impedance approach: after a new integrated circuit (IC) was taped out and manufactured designers gave their first IC prototypes to a validation team. The validation group prepared a Test board for IC testing with numerous low ESR decoupling capacitors included to reduce PDN impedance as required by the prior Art; they might not suspect that resonances and transients were raised, instead and that is why the validation fails. After validation fails, IC prototypes are returned to re-design and re-tape out it. However, the chip might be good, and the problem was in rising on-chip resonances and transient oscillations as a result of too low PDN impedances. We could not even imagine how many designs failed, startups disappeared, and millions of dollars were wasted in the industry because of following the “low” board impedance approach.

The Prior Art method was proposed without proof and detail circuit analysis. As experimental measurements show [12, 13], the reducing PDN impedance, which achieved in [12, 13] by increasing the number of on-board decoupling capacitances, leads to the rising resonance peak in the system. The number of papers expressed the concern on the Power Integrity approach [12-17]. Some designers are including serially connected resistors to the decoupling capacitors, however, the resistors have an undesirable ESL that has negative effect on the PDN, and not an optimal solution.

There are some papers published that noted the usefulness of the PDN damping, for an example [18-21], however, in these papers there are no new relationships revealed that might be used in engineering practice for the PDN design.

It also should be appreciated, that the main chip designer's requirement is to have low voltage variations ΔV on the chip die, and not the target impedance Z_{T}, which was brought by board designers to have some rules for the PCBs design in a lack of a guidance.

It should be appreciated that voltage ΔV, current ΔI, and its relationship ΔV/ΔI in the PDN represents complex functions of the PDN parameters, and not the simple digit as Z_{T} is in the Prior Art. These relationships were established in [17, 18], verified by comparison with an experiment, and showed fine agreement. These obtained relationships are implemented in the current invention to design PDN without resonances, transients, and significant voltage decay.

The Prior Art also includes the Apparatus which might made based on the computer system which selects decoupling capacitors and their parameters based on the calculation of the parameters noted in items [0003] and [0004] above, and defines the number of the capacitances, their parameters, and locations on the PCB to stabilize the voltage in the system, as FIG. 4 illustrates. The initial data comes from the database 410, or user inputs 420 and comes to the PDN Parameters calculator 450 that calculates the PDN parameters, which together with Specification inputs 430 further comes to the Calculation engine 440 which calculates of the PDN impedance. The output data of the Calculation engine 440 together with results of the target impedance Z_{T} calculations done in module 460 based on the device specification inputs 430, comes to the module 470 which verifies if the board impedance is lower than the target impedance Z_{board} (ω)<Z_{T}. If the design is considered successful in module 470, the design solution will proceed to module 475 which verifies if the design meets the manufacturing rules. If the design does not meet the design criteria, after module 470 the module 480 will provide the instructions to the Calculation engine to change the design. In the case of successful design, in module 475 the verification is carried out if the manufacturing rules are satisfied. The information on the manufacturing rules are coming from module 490. If the checking with manufacturer rule is successful, the final design' schematic, graphs, and parameters come out and became available to the user in module 495, which might represent a computer system with a monitor.

### Disadvantages of the Prior Art Apparatus

Modern nm-CMOS devices have the operating frequency in GHz range, current' variations ΔI up to hundreds of Amperes, and required acceptable voltage variations in the millivolt range, which makes a calculated value of Z_{T} being in some microOhms. The Apparatus is guiding developers according to the “low impedance” principle (1). When designers trying to achieve so small PDN impedances according to (1), it creates huge resonances and transients in the assembly, instead. This often leads to the device fail and respin.

### Disadvantages of the Prior Art Design Process

Another very important prior art problem at design and manufacturing of electronic devices is that different parts of the assembly are designed and manufactured by different engineering groups and even by different companies. The assemblies' parts designers, chips designers, especially, typically, would not like sharing the whole information about design, which might be needed to other groups to achieve the high performance of the assembly. Even inside the same company, the designers of the chip are not sharing the whole data, important for the successful design, with the board design group, customers, or external manufacturers. Package designers are also trying to keep in secrecy their design specifics. As a result, the board designers have only basic information about other parts of the product: type of the package, number of package power and ground pins, chip typical consumption, maximum and minimum current, chip' maximum clock frequency, margins for the acceptable voltage variations, size of the PCB and product temperature range, etc. The rest of the chip and package characteristics, like on-die and on-package capacitances, and interconnect ESR and ESL are typically unknown for other groups, customers, and manufacturers. These forces engineering groups of the board, VRM, and package to work with uncertainty which results in frequent re-type outs (respins). The problem is that if the board design is not aligned with the dynamic properties of the package and chip this lack of agreement with the rest of the PDN will result in poor product performance.

Therefore, there is a need to provide a tool, a method, and a process for designers of the different parts of the assemblies, customers, and manufacturers on:

1) how to design and manufacture an assembly of a board with a VRM and decoupling capacitors, a package, and a chip to achieve good PDN performance, without or reduced resonances, voltage and current transient oscillations, and with low voltage Decay;
2) how to design good PDN without having a complete information about design of all parts of the assembly;
3) how to design and manufacture of an assembly by using a process that allows for the different design groups to work in parallel, without disclosing proprietary information that different engineering groups might have.

### SUMMARY OF THE INVENTION

Embodiments of the present invention provide a new method, an apparatus or Tool, and a process to design and manufacture assemblies of VRM-PCB-Decoupling-Package-Chip's PDN with good performance without or low resonances, transient oscillations, and low voltage Decay on the chip die.

It should be appreciated that the present invention can be implemented in numerous ways, such as a method, an apparatus or Tool, or a process on a computer-readable medium. Several inventive embodiments of the present invention are described below. It should be appreciated that the relationships between PDN parameters and variations of voltage ΔV and current ΔI in the PDN were established in [17, 24] and these results allow to design PDN based on the new relationships that also have been verified by the comparison with the experiments [17, 24].

In one aspect of the invention, in order to completely remove resonances and transient oscillations on the chip die, the new design criteria are used—Critical Loop Impedance (CLI) Z_{Crit} instead of the target impedance Z_{T}, like in the prior art. In this invention the CLI is defined based on the condition that calculated voltage variations in a PDN ΔV are lower specified value. The present invention guides that to completely remove resonances and transient oscillations, each PDN loop' impedance should be elevated equal to the CLI, which value for the case of the transient voltage variations is twice the characteristic impedance of the loop Z_{Crit}=2ρ.

In another aspect of the invention, the board impedance Z_{board} should not be too low, but elevated up to the CLI less the impedance of the interconnect of the loop.

It also should be appreciated that increasing board “vertical” impedance that includes the decoupling capacitors should not impact the so-called “horizontal” impedance of the PDN components, which carry direct current from the VRM all the way to the chip' die and should remain low to keep low static and dynamic voltage drop in a PDN.

In other embodiment of the invention, the tool, based on the information about VRM time constant and the value and timing of the decoupling capacitors, calculates if there is enough charge stored in the decoupling capacitors to replenish the charge withdrawn at chip operation and prevent both, voltage variations and significant voltage Decay on the chip die. The Tool guides on decoupling capacitors values and timing to prevent voltage Decay, and on the number of the PDN loops that includes decoupling capacitors.

In another aspect of the invention a method, based on the CLI, calculates the critical ESR of the decoupling capacitors that will not cause the resonances and transient oscillations on the chip die. The calculations include many parameters, like number of package power and ground pins or balls, chip maximum and minimum current, chip' maximum clock frequency, voltage variations, chip power supply voltage, etc.

In other embodiment of the invention, there is a TOOL, or Apparatus that, based on the specific methods and formulas, carries out calculations of the resonances, voltage variations, and voltage Decay, and other PDN parameters and figures of merits.

In another aspect of the invention, the process of the simultaneous PDN design by different design groups in parallel is implemented by the TOOL, which has separate interfaces for each design group: PCB design team, manufacturer team, package design team, chip design team, or customers. The data for each team is provided to the TOOL without disclosure them to other groups the sensitive information that different teams might have.

Other aspects of the invention will become apparent from the following detail description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate structural elements.

FIG. 1 (Prior Art) is an illustration of a pair of conductive planes on the PCB that is used as power and ground planes for the power supply of the assembly of chip-package-PCB.

FIG. 2 (Prior Art) is a simplified model of a Power Delivery Network (PDN).

FIG. 3 (Prior Art) is an illustration of the prior art main guidance.

FIG. 4 (Prior Art) illustrates a prior art apparatus and an algorithm.

FIG. 5 illustrates the present invention' one of the guidance that requires that PDN impedance should be exactly equal, or slightly higher than Critical loop impedance (CLI), which is different compared to the prior art guidance presented in FIG. 3.

FIG. 6 is a simplified PDN schematic for the flat board impedance case when this impedance might be modeled by a resistance.

FIG. 7 illustrates the impact of the not “flat board impedance” to the PDN.

FIG. 8 illustrates a PDN schematic with more details of the chip die and on-board decoupling capacitors for the time-domain PDN analysis.

FIG. 9 illustrates an apparatus and algorithm for the PDN design.

FIG. 10A illustrates the method that became a part of the apparatus that helps to allow simultaneously design PDN by different design groups while keeping the proprietary information for each group private sharing it with the TOOL only.

FIG. 10B illustrates an example of the content of the proprietary and open information that IC design and package design groups might have.

FIG. 11 illustrates the waveform of a signal on the chip' die at one single transition, and parameters of the waveform-figures of merit (FM).

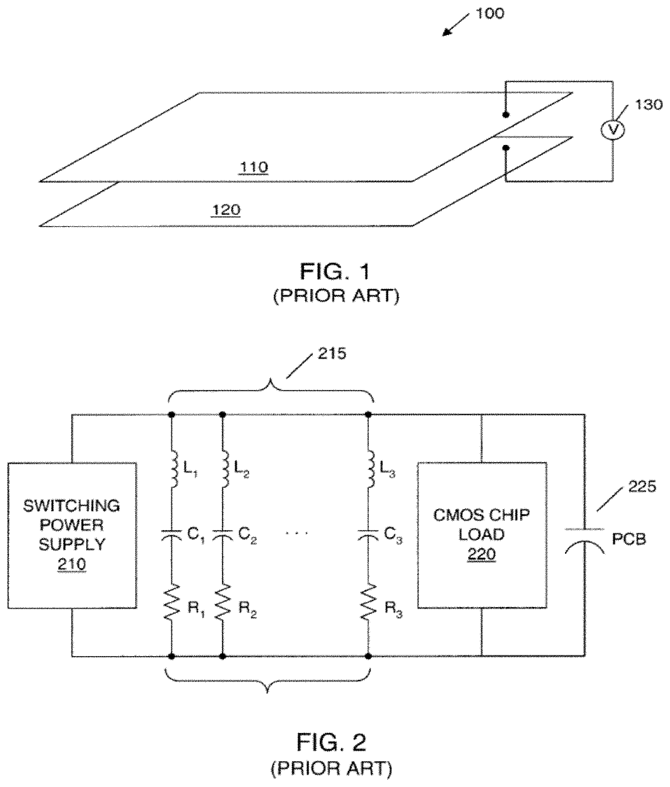

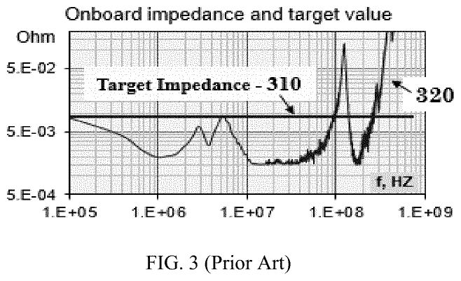

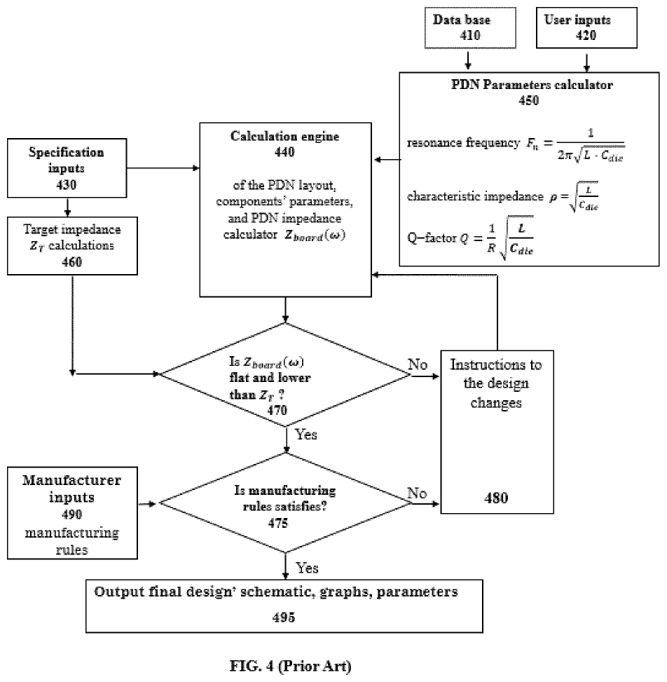

### DETAIL DESCRIPTION OF THE INVENTION

The present invention relates to the design of a Power Delivery Network (PDN) of an assembly of a VRM-Board-Decoupling-Package-Chip for the nm-CMOS devices like IC of Microprocessors, ASICs, FPGAs, etc. The embodiment described herein provides a Method, a TOOL or Apparatus, and a process to design of an assembly with removed, or reduced PDN resonances, voltage transient oscillations, and voltage decay on a chip' die. It should be appreciated that these PDN improvements lead to the reduced number of costly respins of PCB, Package, and Chip designs. It will be obvious to one skilled in the art, that the present invention may be practiced without some or all of specific details. In other instances, well-known process operations have not been described in detail in order not to unnecessarily obscure the present invention.

In one aspect of the invention, in order to completely remove resonances and transient oscillations on the chip die, the new design criteria are used—Critical Loop Impedance (CLI) Z_{Crit} instead of the target impedance Z_{T} like in the prior art. This invention calculates the CLI based on the real PDN schematic parameters and guides that to completely remove resonances and transient oscillations in each PDN loop it impedance should not be low but elevated up to the CLI. In another aspect of the invention, the board impedance Z_{board} should not be too low but elevated and defined based on the CLI less the impedance of the interconnect of the loop.

It should be appreciated that there might be different CLI for the removing the resonances, and for the removing the transient oscillations in a PDN, particular.

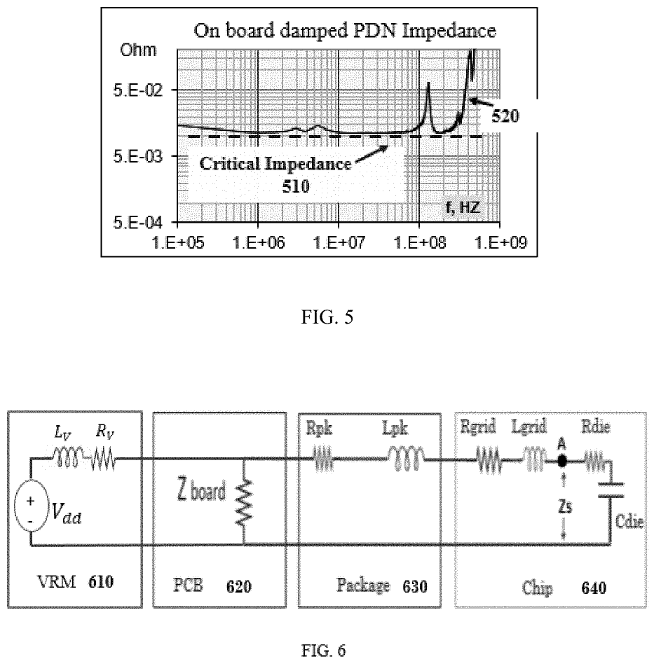

FIG. 5 illustrates the CLI as the new design criteria of the assembly. The critical board impedance is shown by dashed horizontal line 510 and board impedance is illustrated by the solid black line marked 520. When a design is satisfied with these new criteria and board impedance is exactly equal, or slightly higher than the CLI, there will not be resonances and transient processes on-chip die. These new design criteria are different compared to the prior art guidance: the prior art guidance is often interpreted that “low board impedance is always better” which also leads to the device's failures and assemblies respins. From another embodiment of the invention, the board impedance should not be chosen significantly higher compared to CLI, other vice it will limit the current from decoupling capacitors that increases the time of the charge delivery to the on-die capacitor.

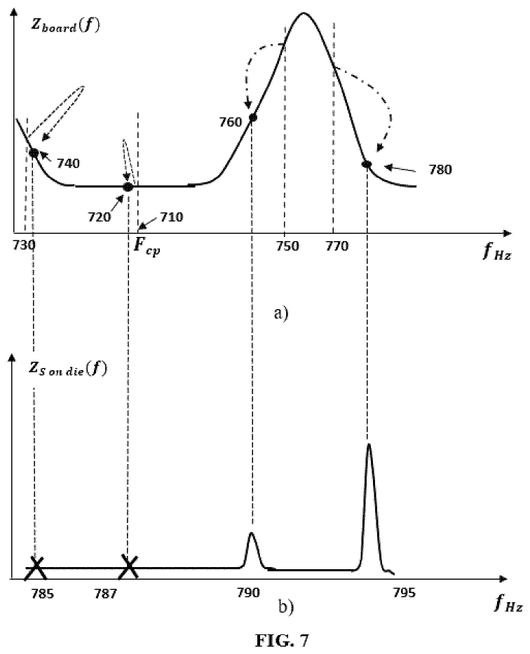

It should be appreciated that even if board impedance created to be flat in some frequency range, the PDN still might have resonances. Flat board impedance may be modeled as a resistor, therefore, the schematic in FIG. 2 (Prior Art) might be redrawn as a simplified schematic in FIG. 6, where the VRM 610 is presented as a simplified circuit that includes an ideal voltage source of voltage V_{dd} which includes VRM internal serial inductance L_{V} and output serial resistance R_{V}. The voltage from VRM is coming through the PCB 620 to package 630, and the chip 640. The PDN goal is to provide a stable and quiet power on the chip die' transistors,—at point A in FIG. 6. One skilled in the art might calculate the system impedance Z_{S} (ω) at this point as an impedance of two parallel circuits:

1) one branch on the left from point A, has an ESR which includes Z_{board}, ESR of a package named Rₚₖ, and ESR of a chip' power and ground grids R_{grid} correspondently. This branch also includes ESL of the package Lₚₖ, and chip' power and ground grids ESL, named L_{grid};
2) another branch includes the on-die capacitor C_{die} and on-die resistor R_{die}. The total ESR of the chip and package is named R_{cp}, and equal to R_{cp}=Rₚₖ+R_{grid}+R_{die}. Obviously, this schematic represents the parallel resonance circuit that might exhibit resonant behavior. The Tool calculates an impedance Z_{S} (ω) of this circuit in point A and the on-die resonance frequency. The frequency domain analysis of the equivalent PDN schematic in FIG. 6 shows that the resonance frequency Fᵣ is:

$$\sqrt{\sqrt{1 + \frac{2}{{Q}^{2}}} - \frac{1}{{Q}^{2}}}$$

This formula is accurate compared to the formula

$${F}_{n} = \frac{1}{2 π \sqrt{L \cdot {C}_{d i e}}}$$

used at the Target Impedance method in Prior Art, which obtained for the ideal parallel circuit without resistances in capacitive and inductive branches of the circuit. However, the real circuit always has some resistances, like it is shown in FIG. 6.

It should be appreciated, that when the value under the square root in the formula for the resonance frequency Fᵣ is negative, the PDN will be resonance free. This defines the critical Q-value for the resonance's removal:

$${Q}_{c r i t} = \sqrt{\sqrt{2} - 1} \approx 0.64 .$$

If Q-factor of a loop is higher compared to the Q_{crit}, PDN will exhibit resonances, and at Q<Q_{crit} the PDN will be resonance-free on the chip die. Therefore, in one aspect of the invention, the TOOL verifies if there are resonances in the PDN loop by calculating the value of the Q-factor of a PDN and compares it with the critical value.

It should be appreciated that Q_{crit} might be calculated by more complex formula than the current example for the more complex PDN schematics.

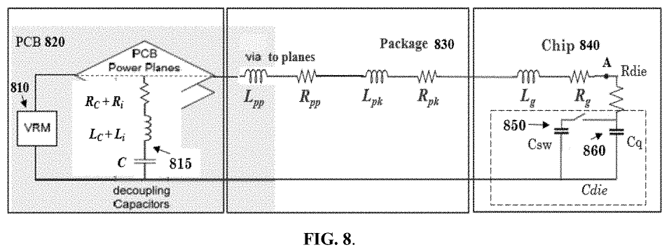

In this embodiment of the invention the TOOL provides calculations and a guidance for the case of more complex PDN schematic,—when a board impedance is not flat. The TOOL calculates the chip and package resonance frequency F_{cp} for the PDN loop from VRM to the package, to the chip die, as on the FIG. 6, and then the TOOL is accounting on how not flat board impedance impacts the on-die PDN performance. FIG. 7 illustrates how adding a board with its impedance Z_{board}(f), presented in FIG. 7a by solid line, impacts the impedance looking from the chip die Z_{S on die}(f),—FIG. 7b. The example of a typical board impedance in FIG. 7a exhibits a negative slope at very low frequencies, a flat part at middle frequencies, and an impedance peak at higher frequencies. The PDN performance on-die depends on how the chip and package resonance frequency F_{cp} position itself with respect to the various parts of the board impedance.

On FIG. 7a there are shown 4 possible typical situations:
1) when a chip and package resonance frequency F_{cp} corresponds to the flat part of the impedance,—position 710. Suppose that the parameters of the package-chip loop are chosen properly and resonances on package-chip loop are removed. At adding the board to this loop the total loop ESR is increasing and Q factor of the assembly will be lower compared to the Q-factor of the chip and package loop without the board. The increased loop ESR will cause a slight shift of the assembly (chip, package, and board) resonance frequency Fᵣ to the lower frequency,—position marked as 720. The cross 787 on the lower graph in FIG. 7 indicates that there is no resonance peak on the die.
2) when a chip and package resonance frequency F_{cp} corresponds to the negative slope marked by the vertical dashed line 730. In this case, the capacitive reactance of the negative slope will be added serially with the on-die capacitance and the resonance frequency of the assembly will be shifted slightly to the higher frequency,—to position 740. However, adding serially big capacitive reactance to the loop will not change the Q-factor significantly and there also will not be resonances on-chip die that illustrates by cross 785 on the lower graph.
3) The third case is when F_{cp} matches the positive slope of a high-frequency peak; this position is marked as 750. The reactance of the positive slope is inductive that will be added to the chip/package circuit inductance and will provide significant changes to the on-die PDN resonance frequency Fᵣ which is moved to the position 760, that shown by the dashed error with the points. With the growing circuit ESL, the characteristic impedance of the circuit is rising and, hence, the Q-factor. Therefore, in this case, there might appear impedance peak on the chip die,—790 in FIG. 7b. The amplitude of this on-die resonance peak is defined, by the value of the positive slope of the peak along with other parameters of the chip and package.
4) In the fourth case the F_{cp} matches the high-frequency negative peak' slope,—this position is marked as 770. The reactance of the negative slope is capacitive and since the resonance peak is at high frequency, the capacitance is relatively small. For example, this capacitance might origin base onboard planes' self-capacitance, or board cavities. Adding the relatively small capacitance serially (instead of Z_{board} in FIG.6) with the on-die capacitance will provide the most significant changes compared to all four cases. The total capacitance of the PDN loop will be significantly reduced that changes the assembly' resonance frequency Fᵣ which moves to position 780. At reducing total PDN loop capacitance, the Q factor will rise to the higher value and in this case, there will appear an impedance peak on the chip die,—795 in FIG. 7b. The position and value of this peak are defined by the position and value of the negative slope around frequency 770 in FIG. 7.

In this embodiment of the present invention the TOOL calculates the contribution of the board impedance to the chip-package loop and includes the results in calculations of the critical board and decoupling capacitors ESR to offset the impact of the board impedance on the system' parameters.

Another specific of the PDN is that the internal power source' impedance R_{V} and serial impedance of the rest of the whole pass from the power supply module to the die should be low enough to keep AC and DC IR drop within the specification limits. This serial pass from the power source to the die includes those PDN components, only, that carry the direct power supply current. These components are R_{V}, Rₚₖ, R_{grid}, and R_{die} and, also, the board spreading planes resistances, and resistances of the package balls and serially connected vias, if any. These components' ESR, named “horizontal”, could not be increased to damp the PDN. In contrast, the “vertical” components' ESR, which are decoupling capacitances, might be increased. Therefore, another embodiment of the invention is rising ESR of the decoupling capacitors' R_{c}, as follows.

The Tool calculates the CLI and based on the calculated results defines the critical ESR value of the decoupling capacitors depending on the decoupling method. The critical value of the decoupling capacitors' ESR provides a critical board impedance which, next in turn, provides a critical Q-factor and, as a result, the resonances on-chip die are removed.

Another specific of the present invention is that method and TOOL helps to remove not resonances, only, but the transient oscillations voltages and currents in a PDN also. It should be appreciated that removing transient voltage and current oscillations requires different conditions compared to the removing the resonances, while both requirements might be related.

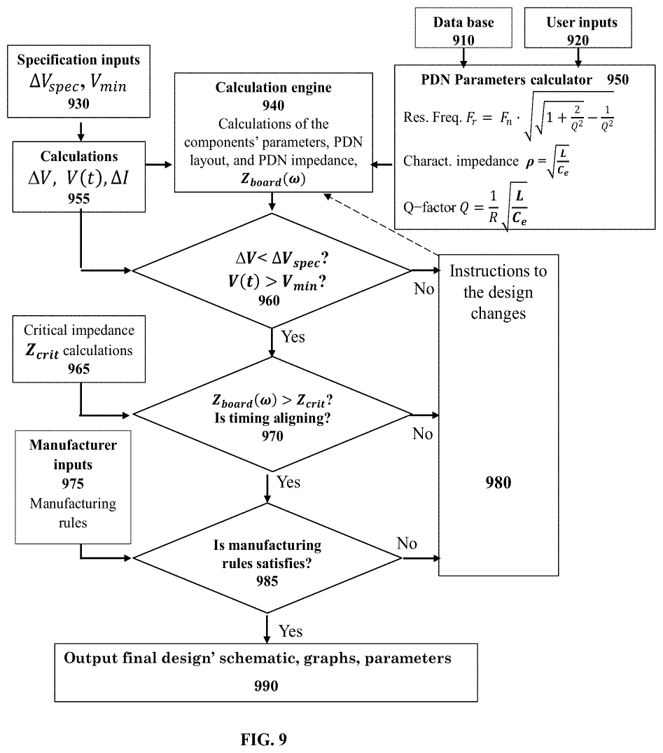

In another embodiment of the invention, the TOOL carries out time-domain calculations of the transient processes in the PDN. More detail PDN schematic, compared to the FIG. 6 that used for the resonances analysis, presented in FIG. 8 for the illustration. The PDN schematic includes VRM 810, decoupling capacitors represented by an equivalent capacitor 815 on the board 820, package 830 where package to the board' power and ground planes ESR and ESL (Rₚₚ and Lₚₚ correspondently) are additionally shown, and Chip 840 where the on-die switching capacitor C_{sw} 850 and on-die quiet capacitance associated with quiet nodes C_{q} 860 are shown. At die operation, some logic elements of a chip die are toggling, and some are quiet. Suppose, that the switching capacitor is fully discharged between transitions. When the transition happens, the switch on FIG. 8 connects the discharged capacitor C_{sw} with the quiet on-die capacitor C_{q} and voltage on-die capacitor C_{die}=C_{q}+C_{sw} drops on so-called instantaneous voltage drop (IVD) value:

$$IVD = Vdd \frac{C s w}{C q + C s w} .$$

The TOOL calculates IVD and uses it for many other calculations of the PDN characteristics.

After voltage drops, the decoupling capacitance starts charging the on-die capacitor C_{die} and voltage on the die capacitor starts rising. These oscillations are named transient oscillations.

It also should be appreciated, that the main requirement of chip designer's is to have low transient voltage variations ΔV on the chip die compared to the specified value: ΔV<ΔV_{spec}, and not the target impedance Z_{T}. Hence, in this embodiment of the present invention the TOOL calculates voltage variations ΔV and current variations ΔI. These calculations are carried out based on the real PDN loop schematic. As analysis shows, voltage variations ΔV and current variations ΔI for the real PDN loop are proportional to the PDN loop characteristic impedance ρ, IVD, and depends on the loop Q-factor and loop impedance by complex way. The TOOL calculates ΔV and current variations ΔI in a real PDN schematic and defines the PDN parameters at which the voltage variations do not exceed the specified level: ΔV<ΔV_{spec}. In one aspect of these calculations the TOOL calculates the CLI at which the transient oscillations will be removed completely. As it is well known from the RLC theory, the transient oscillation in a circuit is removed when Q=ρ/R value is reduced to the Q=0.5, which is a critical Q-factor value. This critical Q-factor achieved at critical loop impedance Z_{Crit}, which is twice the characteristic impedance of the loop Z_{Crit}=2ρ.

In another aspect of the invention, the board impedance Z_{board}, which is PDN impedance from the power rail to the ground rail (named “vertical” impedance), should not be too low, but defined based on the CLI less the impedance of the interconnect of the loop.

In another embodiment of the invention, the TOOL defines the way on how to achieve the CLI. One of the ways is by calculating and setting the elevated critical decoupling capacitors' ESR to remove transient oscillations by equating calculated Q for the real PDN schematic to the Q_{crit}=0.5. From this condition the TOOL defines the critical decoupling capacitors ESR=R_{crit} elevated value and, correspondently, the critical elevated board impedance Z_{Crit}. It should be appreciated, that achieving the CLI to damp the PDN might be done by many different ways, for example, by increasing losses of the interconnect, etc.

It should be appreciated that calculated by the Tool critical PDN parameter's values depend on the chosen decoupling method and type of the chip. For the chips with relatively low consumption the elevated PDN impedance works fine, however, the consumption of the modern nm-chips reaches hundreds of Amperes. For the high consumption chips just to have elevated PDN impedance might not be enough,—at periodically repeated transitions the decoupling system will be depleted, especially during the time when VRM is not react yet. This will cause the reducing PDN voltage—named voltage Decay.

In this embodiment of the invention TOOL calculates the voltage Decay and provides the requirement for the minimum allowable capacitance C value, capacitances needed parameters, and number of the decoupling capacitances N_{G} to keep this voltage decay higher than specified minimum voltage: V>Vₘᵢₙ.

It also should be appreciated, as mentioned above, that rising the PDN loop impedance is limiting the current delivered from the decoupling capacitors to the chip die. This increases the voltage Decay. Reducing the voltage Decay in a PDN requires to reduce the PDN loop impedance,—so, the voltage variations and Decay are controversial requirements. This is another reason not to elevate the PDN impedance too high. In this embodiment of the present invention the TOOL is calculating the controversial requirements and choose the PDN parameters from the compromise between amplitude of the transient voltage oscillations, resonances, and Decay to satisfy both requirements V>Vₘᵢₙ, and ΔV<ΔV_{spec}.

In another aspect of the calculations carried out by the TOOL, it guides to reduce the characteristic impedance ρ, and/or IVD to satisfy the requirement ΔV<ΔV_{spec}. This might not remove the oscillations completely but will reduce oscillations amplitude to the specified value and the voltage Decay will be reduced.

In another embodiment of the present invention the TOOL calculates and guides to use elevated PDN impedance for the removing the transient oscillations, and, simultaneously, to increase the number of the PDN loops to compensate the reduced loops' current to satisfy both noted requirements.

It also should be appreciated, that at periodically repeated transitions in high consumption chips, the total value of the decoupling capacitors should be chosen big enough for each PDN loop to replenish the charge withdrawn from the on-die capacitor until VRM will “wakeup” and increases its current. The time required for the decoupling capacitors in the loop to provide its charge to the on-die capacitor is about three times higher than the PDN loop constant τ=2L/R where L and R are loop' ESL and ESR correspondently. During this time a number of transitions will happen. These transitions withdraw the charge from the on-die capacitance while the decoupling capacitances replenish just some of the withdrawn charges. As a result, the voltage on both, decoupling capacitors and on die capacitance will Decay.

In other embodiment of the invention, the TOOL, based on the information about VRM time constant, value and timing of the decoupling capacitors, and transitions' frequency, calculates if there is enough charge stored in the decoupling capacitors to replenish the charge withdrawn at chip operation that prevents significant voltage Decay on the chip die.

It also should be appreciated that real design requires the implementation of several decoupling capacitors groups and each next decoupling group position further from the IC might have a higher PDN loop time constant and requires higher capacitance value. It should be appreciated that PCB designers are often using next solution,—placing groups of similar decoupling capacitors on top, on-bottom of the board under the package, and on-side of the package in so-called decoupling islands, etc.

In another embodiment of the invention TOOL calculates and guides that time constants of the PDN loops and their total decoupling values should be align to each other and to the VRM' time constant and current in order not to allow PDN voltage fall lower Vₘᵢₙ.

In other embodiment of the invention, the tool is verifying the value and timing of the charge which onboard decoupling capacitors are provided to the on-die capacitor to replenish the charge withdrawn from C_{die} at chip operation, and gives a warning sign to the designers of the chip, package, and board that there is a need to add to the design the on-package and/or on-chip embedded decoupling capacitors and the whole cycle of this interaction design of an assembly is repeating.

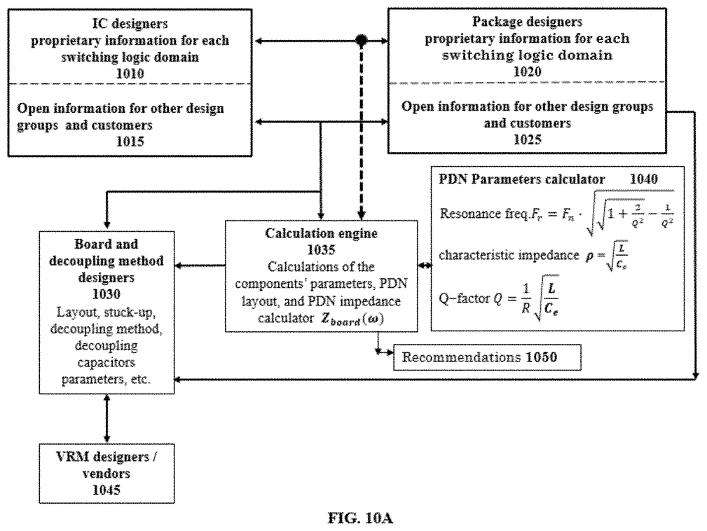

In the next embodiment of the present invention the Apparatus, or another name the Tool, calculates the PDN parameters and guides the PDN design of the assembly according to the new method and algorithm illustrated by FIG. 9. The Tool receives inputs from a database 910 and from a user input 920 of various physical and/or electrical characteristics for a plurality of decoupling components and PDN characteristics. The characteristics of interest include physical dimensions of the ground and power planes and distance between them, type and thickness of dielectric, method and materials of manufacture, capacitances' values, and their ESL and ESR, and ESL and ESR of other assembly components. The apparatus may be implemented based on the computer system that selects decoupling capacitors and their parameters based on the calculations of the initial parameters from the data base and user. The apparatus calculates the number of the capacitances, their parameters, and location on PCB to stabilize the voltage in the system. The initial data that comes from the database 910, or user inputs 920 that includes some initial schematic' and components' values base on which the PDN parameters calculates by PDN parameters calculator 950. Note that calculator 950 calculates the parameters using the different formulas for the resonance frequency compared to the Prior Art. Data from parameters calculator 950 comes to the Calculation engine 940 that starts the design, optimization of the layout, schematic, and components' parameters. From the device specification inputs 930, the PDN voltage waveforms and maximum voltage and current variations are calculated in module 955 instead of the target impedance, as in a Prior Art. The results of the calculations in module 955 comes to the Calculation engine 940 and to the module 960 for the verification based on the new criteria compared to the Prior Art. There are 3 levels of verifications included, not 2 as in the Prior Art, and the first two are different. The first verification 960 compare if the voltage variations ΔV are lower than the specified maximum voltage variations ΔV_{spec} and, also, if the voltage V(t) does not fall lower specified minimum voltage Vₘᵢₙ. If these conditions are satisfied the design solution will proceed to module 970 for the second level of the verification. There will be verified if the designed board impedance is higher compared to the critical impedance Z_{board}≥Z_{crit}. The critical impedance was calculated in module 965. In the module 970 also the timing between VRM, and decoupling capacitances in various PDN loops are verified. If the design passes the second level of verification, the design will come to the 3d verification if manufacturing rules or customers' are satisfied in module 985 where manufacturer rules or customers' requirements come from module 975. If the design does not meet some or all of the design criteria, modules 960, 970, and 985 provide the instructions to the Calculation engine through module 980 to change the design. If the design is successful, the final design' schematic, graphs, and parameters come out and became available to the user in module 990, which might represent a computer system with a monitor.

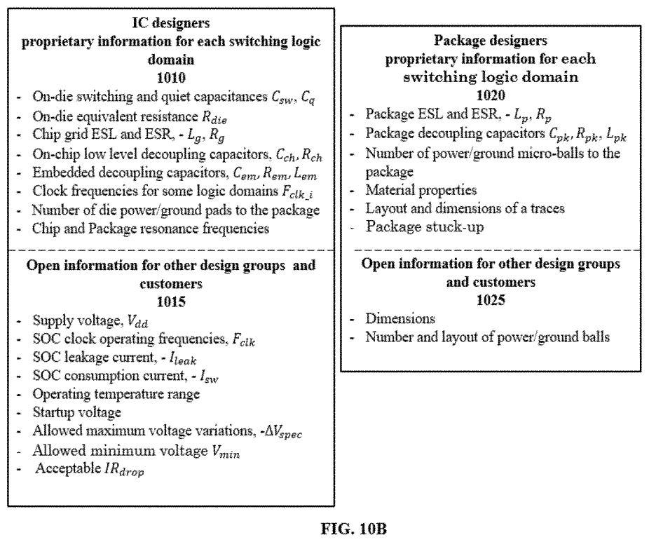

In another embodiment of the invention, there is a process that became a part of the apparatus that helps to solve the important problem of design and manufacturing of an assembly by different engineering groups and allows to keep proprietary information for each group private without negatively impacting the design process. This part of the apparatus is illustrated by FIG. 10A. Each group of designers of chip, package, and PCB that participate in the design of the assembly has its own access to the tool. The IC design group, for example, has two parts of the information: one that should remain private 1010 and another information that might be open to other design groups and/or customers 1015. Package designers have their own private 1020 and open information 1025. The private information might be exchanged between IC design and package design groups and might come also to the Calculation engine 1035 where it will not be accessible by other design groups and/or customers. Open information from package and IC design groups comes to board designers 1030 directly and through the calculation engine 1035 that also exchanges the information with the PDN parameters calculator 1040. The VRM designers 1045 exchange information with the PCB design group. The sensitive information for each design group is handled by the tool and this information also participates in the design process without being disclosed unnecessarily. The calculation engine provides the recommendations 1050 for each group separately through dedicated to each group interface; these interfaces are not shown in the drawing in order not to make it unnecessarily overloaded. FIG. 10B illustrates an example of the content of the proprietary and open information that IC design 1010/1015 and package design 1020/1025 groups might have. Each group might decide depending on the design and other factors which information should be open and which should be private.

The described approach allows for different design groups to start early participation in the design process in a parallel way that reduces the design time, improves the design performance, and reduces or removes respins of the assembly and its parts: chip, package, and board.

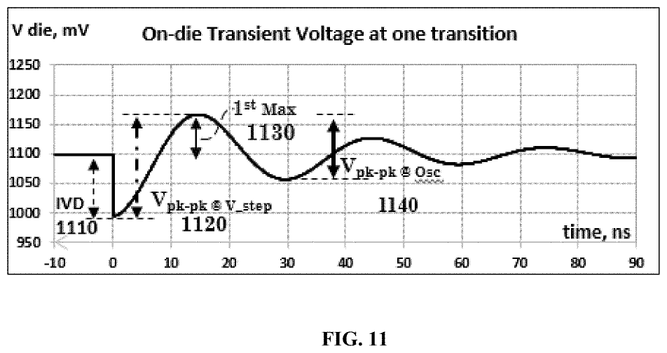

In another embodiment of the invention, the parameters of the voltage waveforms in the PDN, on-die waveform V(t), particular, are calculated. FIG. 11 illustrates waveform parameters at one single transition of the on-die circuit. These parameters characterize the PDN performance and their variations might be conveniently compared with the specified by IC designers voltage margin. These parameters are used as a PDN figure of merit (FM). For example, the Tool might calculate next FMs at one single transition:
Instantaneous relative voltage drop IVD;
The maximum voltage variations ΔV, other words Peak-to-Peak voltage difference between the minimum and maximum voltage 11120 named V_{pk-pk @V_step};
Deviation PDN voltage relative to Vdd due to the 1^{st}, 2^{nd}, . . . MAXs and MINs, the 1^{st} Max (overshoot) is shown 1130;
Maximum span between oscillations' max/min 1140, named V_{pk-pk @0 sc};
   Similar calculations are carried out for the current Start and Stop events at repeated transitions and for specific current profiles, or chip current Loads. This list of the FMs represents just an example and other PDN parameters might be calculated by the Tool, as well.

In another embodiment of the invention, the calculations of the PDN performance and voltage waveforms and parameters might be done by different ways, one of them is based on the calculation of the load current, or current profile that chip demands at different logic patterns, and using the load current the TOOL calculates maximum voltage variations in a PDN ΔV, and then follows the described in the present invention procedure. Another way is to derive current and voltage variations directly from the transitions. FIG. 11 shows the voltage waveform at one transition from which the voltage variations ΔV for each one transition might be derived. The result of voltage variations at repeated transitions also calculated and undergo the described in the present invention procedure—calculating CLI, Q-factor, characteristic impedance, IVD, and other figures of merit.

It should be appreciated that other noise sources in a PDN might present and be significant, like ripples from a power source (VRM), power rail coupling with signals, or another power rails, reflections from the PCB edges, cavities resonances, etc. In another embodiment of the invention these noises might come from the specification or calculated by the TOOL based on the schematic and layout analysis.

It should be appreciated that the apparatus or TOOL carries out calculations in both, Frequency domain and Time domain, as described above. A typical PDN has several PDN loops with decoupling capacitors and the on-die capacitor. In this embodiment of the invention, the TOOL is calculating the resonances, transients, and voltage Decay, Q-factors, characteristic impedances, and resonance frequencies: on the die, on the package, and on PCB including various parameters and resonances that different components, like decoupling capacitors, might have between each other and present them in the matrix form: Q-matrix Qᵢⱼ, resonances matrix Fᵢⱼ, characteristic impedance matrix ρᵢⱼ, and ESR matrix Rᵢⱼ, etc. These matrixes characterize the interactions between different parts of the assembly and might present results of the calculations in a matrix form. The apparatus (TOOL) might present results of the calculations in a digital form, or the form of graphs, etc.

### REFERENCES

[1] U.S. Pat. No. 6,195,613, February 2001

[2] U.S. Pat. No. 6,532,439, March 2003

[3] U.S. Pat. No. 6,789,241, September 2004

[4] U.S. Pat. No. 6,850,878, February 2005

[5] L. D. Smith, R. E. Anderson, D. W. Forehand, T. J. Pelc, T. Roy, “Power Distribution System Design Methodology and Capacitor Selection for Modern CMOS Technology,” IEEE Transactions on Advanced Packaging, Vol. 22, No. 3, P284, August 1999

[6] L. D. Smith, R. E. Anderson, T. Roy, “Chip—Package Resonance in Core Power Supply Structures for a High Power Microprocessor”, Proceedings of IPACK, 2001

[7] L. Smith, “Frequency Domain Target Impedance Method for Bypass Capacitor Selection for Power Distribution Systems”, DesignCon 2006

[8] L. Smith, D. Becker, S. Weir, I. Novak, “Comparison of Power Distribution Network Design Methods”, TecForum, DesignCon 2006. [4]

[9] S. Sun, L. Smith, P. Boyle, “On-Chip PDN Noise Characterization and Modeling”, Designcon 2010

[ ] L. Smith, E. Bogatin, “Principles of Power Integrity for PDN design”, Prentice Hall, 2017

[11] L. Smith, “Impedance and Transient Current Fundamentals”, Tutorial “System Power Integrity”, Part 1, DesignCon 2015.

[12] I. Zamek “SOC-System Jitter Resonance and Its Impact on Common Approach to the PDN Impedance”, Altera Corp., San Jose, 2008.

[13] I. Zamek, “Nm-System's Jitter Resonance induced by PDN noise of toggling on-die Logic”, DesignCon 2010

[14] I. Zamek, “On-chip Jitter and system Power Integrity”, DesignCon 2012

[15] I. Zamek, “Does ‘better’ PDN result in better product performance?” Tutorial “System Power Integrity”, part 2, DesignCon 2015.

[16] L. Smith, S. Sandler, E. Bogatin “Target Impedance Is Not Enough”, Signal Integrity Journal, January 2019.

[17] I. Zamek, “Power Integrity Principles for nm-CMOS devices”, August, DesignCon 2021.

[18] Vivek De, et el., “A Band-Limited Active Damping Circuit With 13 dB Power Supply Resonance Reduction” IEEE JOURNAL OF SOLID-STATE CIRCUITS, VOL. 43, NO. 1, JANUARY 2008.

[19] Z. Peterson, “The Role of a Decoupling, Inductance, and Resistance in a PDN”, Altium, July 2019.

[20] Y. Kobayashi, R. Kobayashi, “Power supply noise suppression by optimizing on-die PDN impedance”, 2012 2nd IEEE CPMT Symposium Japan

[21] M. Coenen, A. Roermund, “Resonant-Free PDN Design”, IEEE 8th workshop on EMC of Integrated circuits, 2011

[22] M. Togashi, C. Burket, “ESR Controlled MLCCs and Decoupling Capacitor Network Design”, DesignCon 2007

[23] H. Ishida, J. Prymak, C. Burket, and I. Novak, “Controlled ESR Capacitors Have Arrived,” DesignCon 2007.

[24] I. Zamek, “New Power Integrity Methodology and mitigation effect of PDN voltage decay”, DesignCon, April, 2022

[25] Provisional Patent Application No 63/262,340 filed Oct. 9, 2021, and entitled “Method and Apparatus for design a PDN of an assembly of VRM-Board-Decoupling-Package-Chip”, author ILIYA GAVRIILOVICH ZAMEK

1. A Method, a Tool, and a Process of calculating parameters and design of a Power Delivery Network (PDN) of an assembly of VRM-Board-Decoupling-Package-Chip for the nm-CMOS devices, that suffers from the resonances, transient voltage and current variations, and voltage Decay, which resulted in the assembly specification fails that often considered as a design flaw and leads to the costly chips respins, comprising:
calculating resonances and transient voltage variations in the PDN loop, and defining from these calculations the critical loop impedance (CLI) at which the resonances and transient oscillations in a PDN are damped completely, or have satisfied specification values, further calculating and setting each PDN loop' impedance elevated up to the CLI, and board impedance equal to the elevated loop impedance less the impedance of the interconnect of the PDN loop from the board to the chip die;
reducing the loop characteristic impedance to decrease the amplitude of the resonances and transient oscillations to the acceptable values and increasing a number of PDN loops and decoupling value to achieve a compromise between acceptable voltage variations and voltage Decay, with the voltage being not lower than the specified minimum voltage;
setting the values of the time constants of the VRM and PDN loops aligned with each other such way that when one of the PDN loops exhausts its charge in its specific time, another PDN loop will continue providing charge and current instead, reducing the voltage variations and Decay.

2. The Method of claiml, wherein setting critical board impedance and critical Q-factor, which set based on the calculations of the CLI to damp PDN, might be done by number of different ways, for example, by setting elevated ESR of decoupling capacitors, or by increasing the losses of the interconnect to the decoupling capacitors.

3. The Method of claim 1, wherein CLI might be different for removing the resonances and removing the transient voltage and current oscillations, while these CLI values are related: at removing the transient voltage oscillations the value of the CLI is equal to the twice characteristic impedance that results in a critical loop Q-factor, while at removing the resonances the critical loop Q-factor might have a different value.

4. The Method of claim 1, wherein PDN loop impedance set lower CLI which enables resonances and transient oscillations in a loop and keeping these resonances and transients under control, lower the specified values.

5. The Method of claim 1, wherein reduction of the voltage variations to current variations ΔV/ΔI is achieved by setting reduced characteristic impedance of the PDN loop by rising on-die capacitance and/or on-chip, on-board, and on-package decoupling, and/or reducing loop equivalent series inductance, where the last one might be achieved by number of different ways, particular, increasing a number of the decoupling capacitances and/or increasing a number of the package power and ground balls (pins) and/or a number chip micro balls.

6. The Method of claim 1, wherein calculation of the characteristic impedances, Q-factors, Board impedances, etc., of each loop includes the contribution of all other loops and might be calculated in a scalar or matrix form.

7. The Method of claim 1, wherein rising the total decoupling value in a PDN to prevent voltage Decay,—when voltage should not fall lower specified minimum value.

8. The Method of claim 1, wherein setting board impedance elevated should be done without impacting “horizontal” impedance that includes serially connected components which carry current from the VRM to the chip die, including VRM output impedance, board and package planes' spreading impedances, chip power and ground grids, impedances of interconnects, etc., to keep low AC and DC voltage drop.

9. The Method of claim 1, wherein various other noise sources like ripples from a power source (VRM), power rail couplings, reflections from the PCB edges, cavities resonances, etc., also are included into calculations; the data of these and other noise sources might be derived from the corresponding PDN' parts specifications, or the measurements, enabling a measurement assisted PDN design.

10. The Method of claim 1, wherein the voltage variations in a PDN, which undergo the described in the present invention calculations, are obtained by two different ways: one based on the calculation of the current load (current profiles), and other way is by calculating voltage and current variations directly based on the sequence of the logic transitions on a chip.

11. A Method of claim 1 wherein might be realized as a Tool or Apparatus that uses computer medium with program instructions that carries out the calculations according to the described in the invention detail description, guides the design process, and comprising the special Tool interfaces for the users.

12. A Method, a Tool, and a Process of calculating parameters and design of a Power Delivery Network (PDN) of an assembly of VRM-Board-Decoupling-Package-Chip for the nm-CMOS devices, comprising separate interfaces for each design group allowing sharing the sensitive information that the group might have with the Tool or Apparatus only, without disclosing the proprietary information with another groups, like chip design group, package design group, board design group, customers, etc., enabling the process of early mutual design by different engineering groups without losing by each group the important design information.

13. The Method of claim 12, wherein further comprising interfaces for the presenting the results of the PDN design, allowing important parameters and figures of merit be shared with all users, as well as separate interfaces for each design group with proprietary information, guiding what else should be done for the assembly performance improvement, which enables the process of mutual design by different engineering groups early.

14. The Method of clime 1, wherein further comprising including a traditional EDA simulation tools like SPICE, ADS, etc., as well, as a common computational tools like MATLAB, Excel, to perform calculations that described in present invention Method or TOOL should carries out, as well as any additional calculation of the PDN parameters and dependances.
